(19) United States
(12) Patent Application Publication
(10) Pub. No.: US 2013/0037141 A1
(43) Pub. Date: Feb. 14, 2013

(54) TRANSMISSION ANTI-LEAK VALVE

(71) Applicants: James A. Kujawski, JR., Attica, NY (US); Arthur J. Murray, Medina, NY (US); Joseph Anthony Giarrizzo, Amherst, NY (US); Robert Stoll, Soso, MS (US); Kip R. Steveley, Rochester Hills, MI (US); James Caroll, Novi, MI (US); James Messecar, SR., Wyoming, NY (US)

(72) Inventors: James A. Kujawski, JR., Attica, NY (US); Arthur J. Murray, Medina, NY (US); Joseph Anthony Giarrizzo, Amherst, NY (US); Robert Stoll, Soso, MS (US); Kip R. Steveley, Rochester Hills, MI (US); James Caroll, Novi, MI (US); James Messecar, SR., Wyoming, NY (US)

(73) Assignee: JIFFY-TITE COMPANY, INC., Lancaster, NY (US)

(21) Appl. No.: 13/548,468

(22) Filed: Jul. 13, 2012

Related U.S. Application Data
(60) Provisional application No. 61/507,749, filed on Jul. 14, 2011.

(51) Int. Cl. F03B 15/00

(52) U.S. Cl. 137/561 R

(57) ABSTRACT

A valve is mounted in a first bore in a first separable section of a transmission to block or allow fluid flow through the first bore to a second bore in a second transmission section depending on whether the first and second sections are joined together or separated. A movable portion of the valve is responsive to an actuator during relative movement of the transmission sections between fluid flow open and fluid flow closed positions. The valve can include a valve housing fixed in the first bore and a carrying plunger biased to the fluid blocking position and responsive to the actuator for movement to the fluid flow open position. The valve forms a fluid flow path between the first and second bores across the gap between the facing surfaces of the joined transmission sections.

### CROSS REFERENCE TO CO-PENDING APPLICATION

The present application claims priority benefit to the Jul. 14, 2011 filing date of provisional patent application Ser. No. 61/507,749 for a TRANSMISSION ANTI-LEAK VALVE filed in the names of James A. Kujawski, Jr., Kip R. Steveley, James Caroll, James Messecar, Sr., Arthur J. Murray, Joseph Anthony Giarrizzo and Robert Stoll, the entire contents of which are incorporated herein by reference.

### BACKGROUND

The present invention relates, in general, to vehicle transmissions and specifically to vehicle transmissions having two or more separable sections and, even more specifically to anti-leak valves for vehicle transmissions having two or more separable sections

One type of vehicle transmission design has two or more separate sections. The sections are joined together to establish flow paths for proper operation of the transmission. A fluid transition member is mounted in one of the bores in the two transmission sections and sealingly engages the corresponding bore in the other transmission section to establish a flow path between the bores in the two transmission sections when the two transmission sections are joined together. The transition member is typically formed of a seal material to establish a fluid seal connection in the bores in the two transmission sections; while at the same time establishing a fluid flow path between the two bores through the hollow interior of the transition member.

Occasionally, the transmission sections need to be separated for service at the manufacturing site or at a repair facility. Opening the transmission after it has been filled with transmission fluid causes the transmission fluid to leak from the separated transmission sections. Not only is the leak messy, the transmission fluid is toxic and it will contaminate the nearby floor and service bay and pose a safety hazard to service personnel.

It would be desirable to provide a means to prevent fluid leakage when separable sections of a transmission are later opened.

### SUMMARY

A transmission has at least first and second separable transmission sections, with a first fluid flow path including a first bore in the first separable section disposed in fluid flow communication with a second bore in the second separable section. A valve mounted in the first bore to block fluid flow from the first bore when the first and second separable sections are separated. The valve is movable in response to engagement with an actuator, from the first fluid flow blocking position to a second position opening fluid flow through the first bore. The actuator is responsive to the joining and separation of the first and second transmission sections.

The valve includes a housing fixedly mountable in the first bore in the first transmission section. In one aspect, a plunger is movably mounted within the valve housing and has first and second opposed ends. The first end of the plunger is disposed exteriorly of the valve housing for movable contact or disengagement with an actuator in the second transmission section as the first and second transmission sections are joined or separated.

A first seal member is carried on the valve housing for sealing the housing in the bore. A second seal member is carried on the plunger, for sealing the plunger to an interior surface of the valve housing when plunger is in the first fluid flow blocking position.

A biasing means, carried in the valve housing, biases a plunger to the first position.

The plunger includes a stem carrying a plurality of radially outwardly extending ribs, the ribs defining axial flow paths along the stem. A cap is fixedly engageable with the stem. The cap includes an exterior surface engageable with an inner surface of the valve housing when the plunger is in the first position defining the first fluid flow blocking position of the valve.

In one aspect, the stem, rib and the cap are integrally formed as a unitary one-piece member mountable as a unit within the valve housing.

An exterior seal member is mountable over an end portion of the valve housing extending exteriorly of the bore in the first transmission section; the exterior seal member is engageable with an inner surface of the second bore in the second transmission section when the first and second transmission sections are joined together in a fixed relationship.

In another aspect, a biasing means is carried on the valve and engageable with a portion of the first separable transmission section for normally biasing the valve to the first position.

The actuator is responsive to separation and engagement of the first and second separate sections of the transmission for moving the plunger of the valve between the first and second positions.

In another aspect, the valve includes a body having opposed first and second ends, an internal bore formed in the body extending from the first end to a closed second end intermediate the first and second ends of the body, and at least one aperture in the body disposed in fluid flow of communication with the internal bore in the body to allow fluid flow through the internal bore in the body and the first bore in the first transmission section when the valve is in the second position. The at least one aperture can include a plurality of radially extending, circumferentially spaced apertures.

The valve further can include an angularly movable leg carried adjacent the second end of the body for engaging a portion of the interior surface of the first bore in the first transmission section to position the valve in the first position when the first and second transmission sections are separated. The angularly movable leg can be carried on a cap separably joinable to the body.

Means are provided, responsive to separation and engagement of the first and second separate sections of the transmission, for moving the valve between the first and second positions. The moving means comprises a protrusion extending from the second separable section through the opening in the bore in the first section when the first and second sections are joined together to engage and move the valve from the first position to the second position. The protrusion can be mounted in a bore in the second section.

An inner diameter of the bore in the first transmission section and an outer diameter of one end portion of the valve housing are configured for an interference fixed mounting of the one end of the valve housing in the first bore in the first transmission section.

A retainer is carried in the valve housing and defines a seat for the biasing means. An aperture is formed in the retainer to define a portion of a fluid flow path through the one end portion of the valve housing; a crimp on an end portion of the one end portion of the housing fixes the retainer in the one end of the housing.

The interface is provided to span and couple the first bore in the first transmission section in fluid flow communication with the second bore in the second transmission section when the first and second transmission sections are joined together. In one aspect, the interface includes the valve sealingly coupled to the first bore and the second bore when the first and second transmissions sections are joined together.

In another aspect, the interface includes a tubular member sealingly coupled in the second bore of the second transmission section. The valve in the first bore of the first transmission section sealingly engages and couples to an end of the tubular member when the first and second transmission sections are joined together.

In one aspect, the valve defines a fluid flow path between the first bore and the first transmission section and the second bore and the second transmission section when the first and second transmission sections are joined together.

### BRIEF DESCRIPTION OF THE DRAWING

The various features, advantages and other uses of the present transmission anti-leak valve will become more apparent by referring to the following description and drawings in which:

FIG. 1 is an exploded perspective view of a transmission with separable sections shown in the separated, spaced apart state, with one aspect of anti-leak valves mounted in one transmission section in a fluid blocking, closed position;

FIG. 2 is a side-elevational view of one of the anti-leak valves shown in FIG. 1;

FIG. 3 is a cross-sectional view of the valve generally taken along line 3-3 in FIG. 2;

FIG. 4 is an exploded perspective view showing the components of the valve shown in FIGS. 2 and 3;

FIG. 5A is an enlarged, perspective view showing the valve in an open, fluid flow position;

FIG. 5B is an exploded, perspective view of the plunger and cap shown in FIG. 5A;

FIG. 6 is a perspective view of a multi-sectioned transmission in a closed, joined state with the anti-leak valves depicted in a fluid flow, open position;

FIG. 7 is a perspective view of another aspect of an anti-leak valve for use in the multi-section transmission shown in FIG. 1;

FIG. 8 is a perspective view of the multi-sectioned transmission of FIG. 6 in a closed, joined state with another aspect of the anti-leak valves depicted in a fluid flow, open position;

FIG. 9 is an enlarged, perspective view of the aspect of the valve shown in FIG. 8;

FIG. 10 is a longitudinal cross-sectional view of the aspect of the valve shown in FIG. 8, generally taken along the line 10-10 in FIG. 9;

FIG. 11 is an enlarged perspective view of the valve body employed in the valve in FIGS. 9 and 10;

FIG. 12 is an enlarged perspective view of the cap mounted on the valve body depicted in FIG. 11;

FIG. 13 is an exploded perspective view of a transmission with separable sections shown in the separated, spaced apart state, with the aspect of the valve shown in FIG. 9-11 depicted in a fluid flow blocking, closed position;

FIG. 14 is an enlarged, perspective view of another aspect of an integral valve body and cap;

FIG. 15 is a perspective view of a multi-section transmission in a closed, joined state with the anti-leak valves showing the aspect depicted in FIG. 14 in a fluid flow, open position; and

FIG. 16 is an exploded perspective view of the transmission with separable sections shown in the separated, spaced apart state, with one the aspect of the valves shown in FIG. 14 depicted in a fluid flow blocking, closed position.

### DETAILED DESCRIPTION

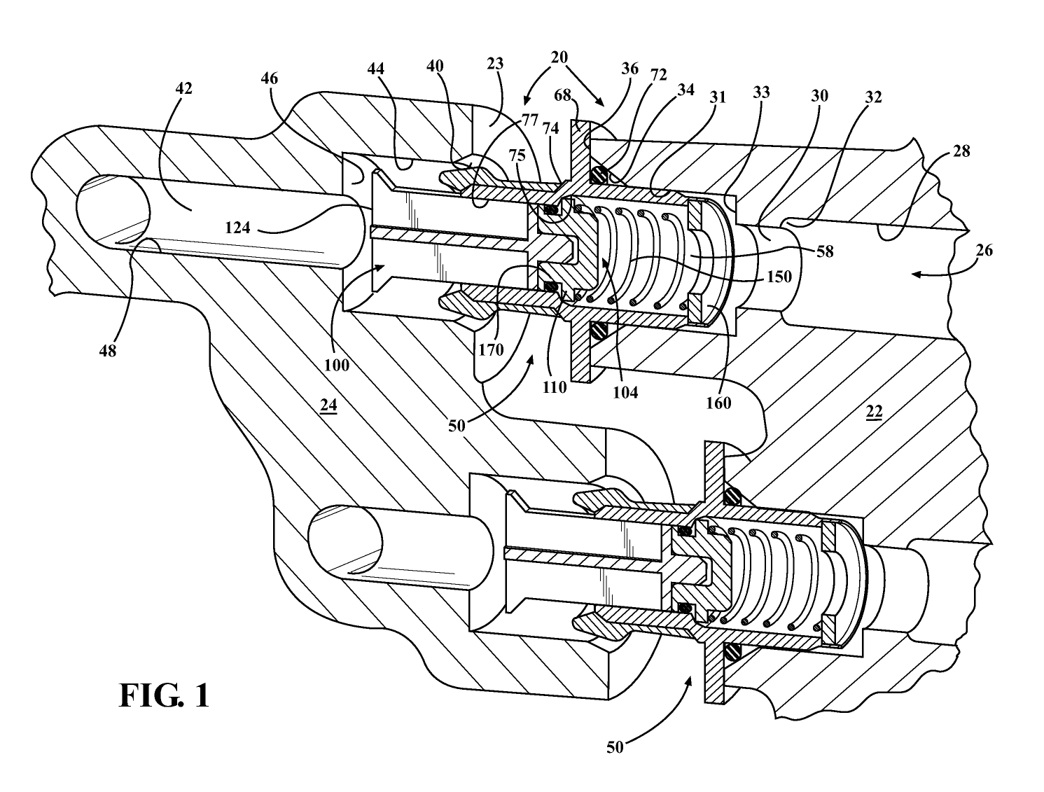

Referring now to the drawing, and at least to FIG. 1 in particular, there is depicted a cross sectional view of a transmission which is designed with separable sections. The transmission 20 includes, by example only, section 22 and section 24.

For clarification purposes, the transmission sections 22 and 24 are depicted in FIG. 1 in a normal separated operative position. Separation of the sections 22 and 24 opens the internal fluid flow paths of each section 22 and 24 and would typically lead to leakage of the transmission fluid out from the internal passageways of transmission sections 22 and/or 24.

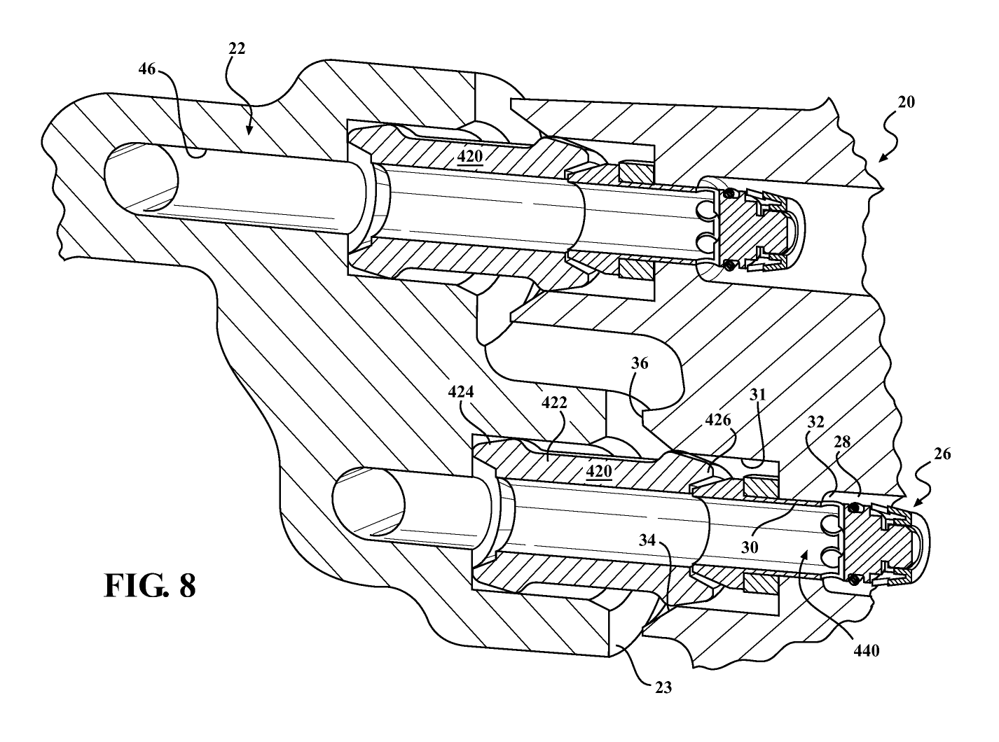

By way of example, transmission sections 22 and 24 include at least one fluid flow passageway with two fluid flow passageways shown only by example. The at least one fluid passageway in the two transmission sections 22 and 24 is formed of a first bore 26 in the transmission section 22 and the second bore 42 in the transmission section 24. The bore 26 has, by way of example, an irregular inner diameter shape, which necks down from a first diameter 28 to a smaller second diameter 30 to form a shoulder 32 at the transition between the first and second diameters 28 and 30. The bore 26 continues from the second diameter 30 past a shoulder 33, through a large diameter bore section 31 shown in FIGS. 1 and 8 to an opening 34 in the outer edge 36 of the transmission section 22 which faces or opposes an exterior surface 23 of the opposite transmission section 24.

The other section 24 of the transmission 20 has an opening 40 aligned with the opening 34 in the transmission section 22. The opening 40 is at one end of a bore denoted generally by reference number 42. The bore 42 includes a first bore section 44 extending from the opening 40 at a first diameter to a shoulder 46. The bore 42 transitions at the shoulder 46 to a second smaller diameter bore section portion 48 which continues through the bore 42 to other fluid flow passage ways within the transmission section 24.

It will be understood that the transmission sections 22 and 24 have a similar second pair of bores coaxially aligned, as shown in FIG. 1, to form a second fluid flow passageway.

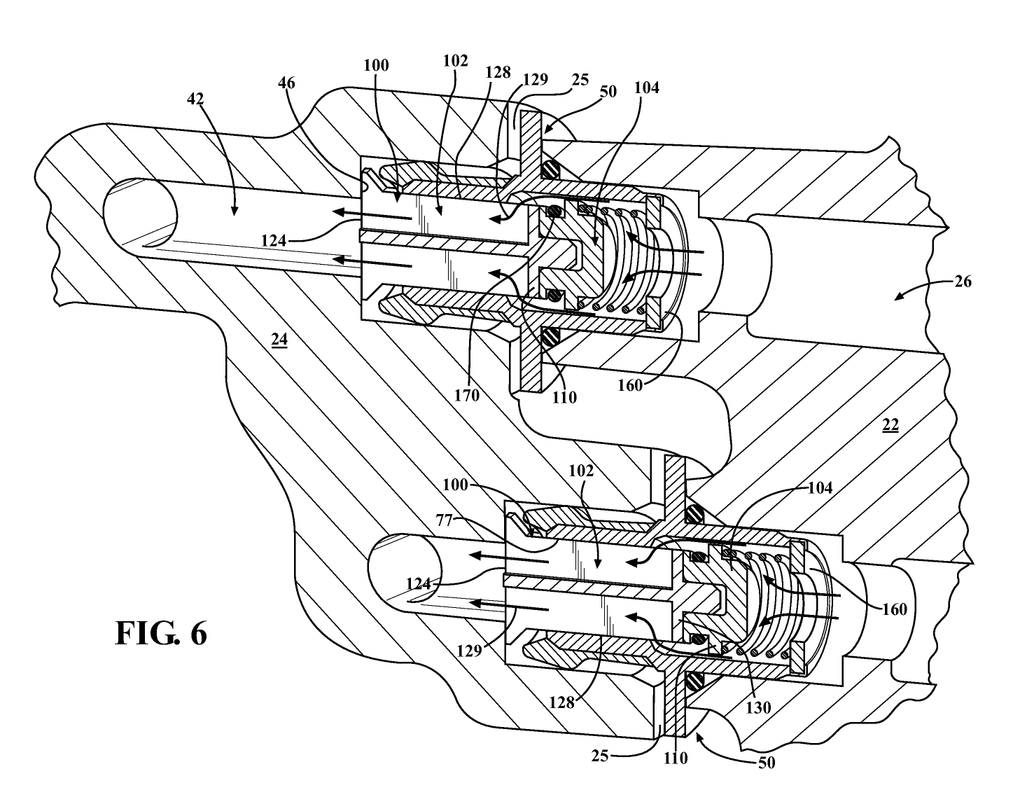

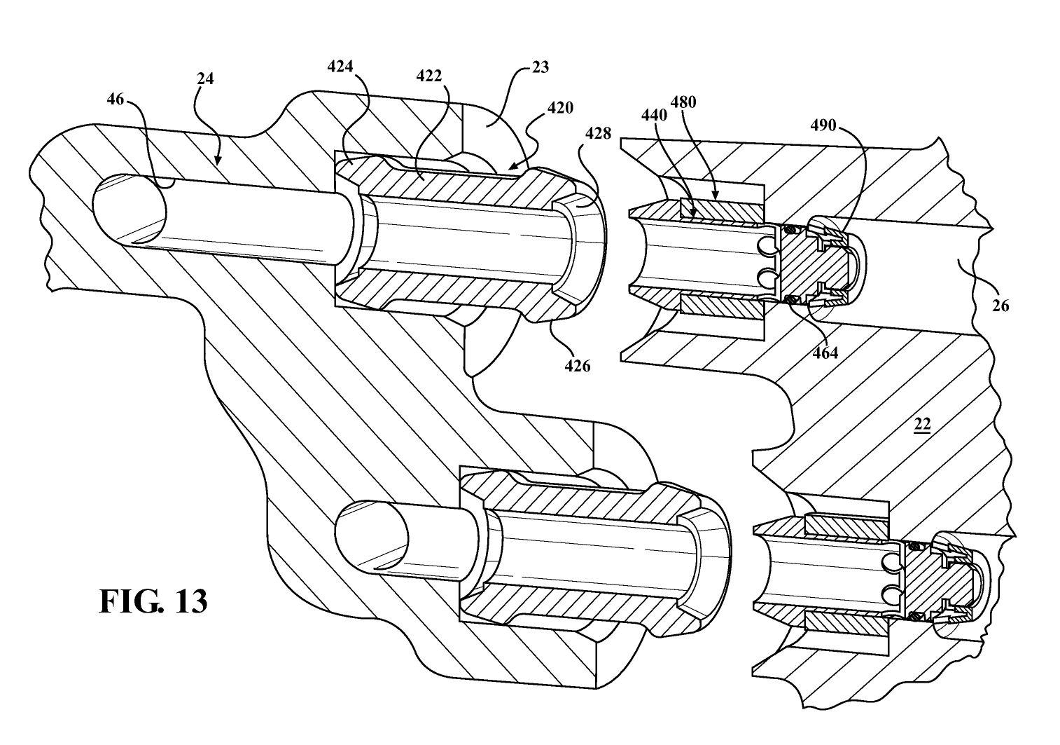

Although it is possible to form the opposed facing surfaces of the transmission section 22 and 24, with precision machine surfaces such that the open ends of the bores 26 and 42 are coaxially aligned and made without any leakage of fluid from the aligned bores 26 and 42, due to the typically irregular shape of the facing surfaces of the transmission sections 22 and 24, a small gap as shown by reference number 25 in FIG. 6, exists between the opposed faces of the transmission sections 22 and 24 even when the transmission sections 22 and 24 are in the joined, closed together position shown in FIG. 6. The gap 25 extends between the open ends of the bores 26 and 42. In prior transmissions of this type, a transition member shown in FIGS. 8 and 13 and described hereafter, is mounted in one of the bores. The transition member is in the form of a hollow tube constructed or covered with a sealing material. In one example, one end of the transition tube is mounted in the second bore 42, with an outer end projecting outward from the open end of the second bore 42. When the first and second transmission sections 22 and 24 are joined together, the outer end of the transition tube sealingly engages an inner surface in the bore 26 in the transmission section 22 to form a sealed fluid flow passageway between the first and second bores 26 and 42.

The no-leak feature of the transmission 20 is provided by a pair of valves, each noted by reference number 50 which are mounted in fluid communication in the aligned bores 26 and 42 in each passageway in the transmission sections 24 and 22, respectively. As each valve 50 is identically constructed, the construction and operation of the valve 50 will be understood to apply to both valves 50 shown in FIG. 1.

Each valve 50 is mounted in one of the bores 26 or 42 of the transmission sections 22 and 24. By way of example only, the valve 50 is mounted in the transmission section 22 in the first bore 26 as, in one example; the transmission section 22 provides a pressurized fluid flow through the first bore 26. The valve 50 functions to close or block fluid flow through the open end of the bore 26 when the transmission sections 22 and 24 are separated. Conversely, the valve 50 allows fluid flow between the first and second bores 26 and 42 on the transmission sections 22 and 24 wherein the sections 24 and 22 are joined together.

In one aspect, the valve 50 forms a fluid flow path between the first bore 26 and the second bore 42 when the transmission sections 24 and 22 are joined together across the gap 25 between the facing surfaces of the transmission sections 22 and 24.

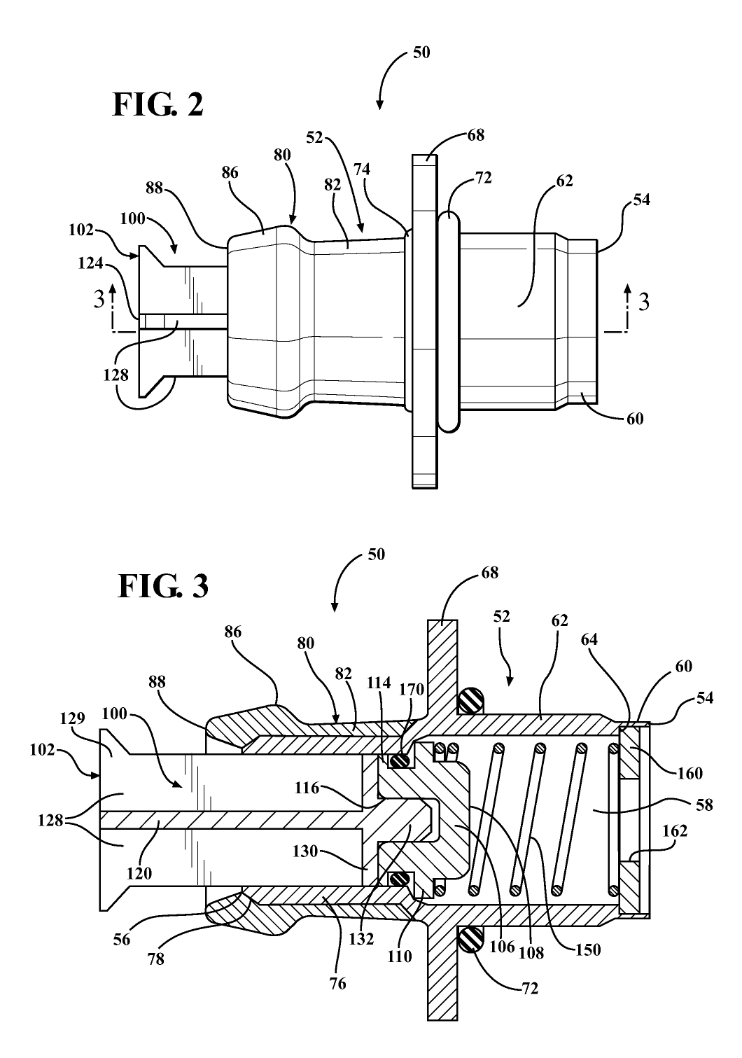

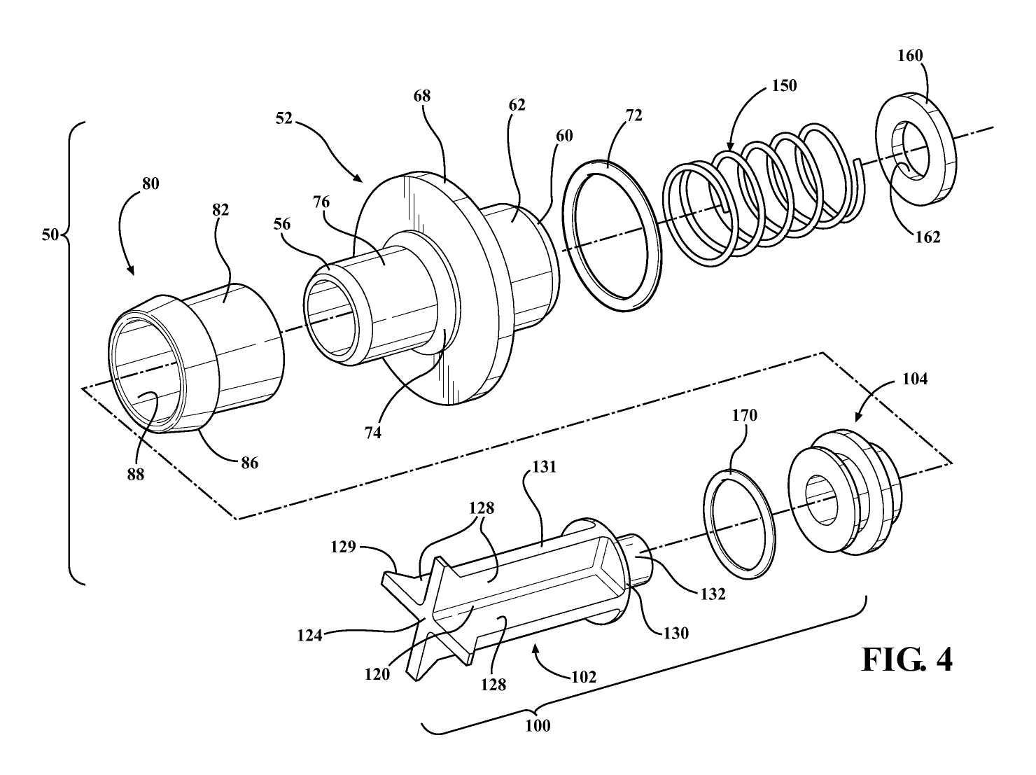

As shown in FIGS. 2, 3 and 4, the valve 50 includes a one piece body or housing 52 which is shown in its partially assembled state in FIGS. 2-4. The housing 52 has a first end 54 and an opposed second end 56.

A bore denoted generally by reference number 58 in FIGS. 1, 3 and 5A extends through the body 52 from a first 54 to the second 56.

The housing 52 has a thin wall section 60 extending from the first end 54 to an enlarged wall thickness section 62. A generally flat or 90° shoulder 64 is formed internally of the thin wall section 60 at the junction with the thicker wall section 62. Similarly, an outward tapered shoulder 66 forms the transition from the thin wall section 60 to the larger thickness section 62.

The larger thickness section 62 has a constant diameter outer surface 64, the purpose of which will become more apparent hereafter.

The larger thickness wall section 62 terminates in an angularly extending, radially outward enlarged flange or collar 68. The juncture of the end of the thicker wall section 62 and the inner most periphery of the flange or collar 68 defines a corner 70 which may be enhanced by a small recess or groove suitable to retain a seal member, such as an O-ring 72, in the corner 70.

The collar 68 defines a stop surface which engages one exterior surface of the one transmission section, such as exterior surface 36 on the transmission section 22 surrounding the opening 34 in the bore 26.

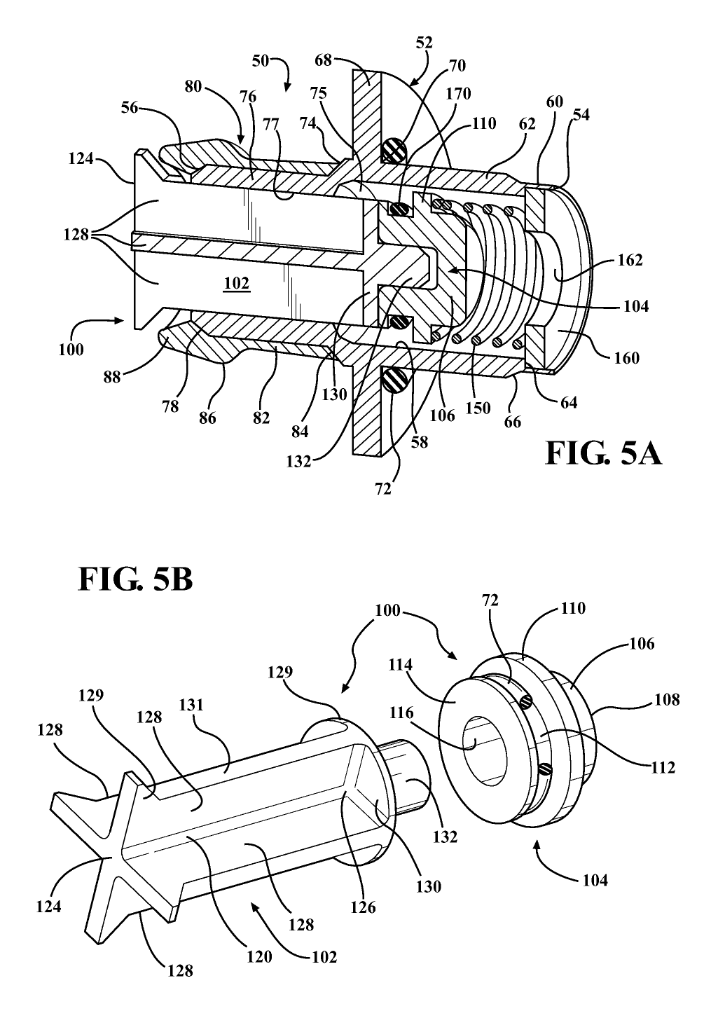

The valve housing 52 continues from the collar 68 to an angularly in turned conical section 74 which transitions into a constant diameter end section 76 terminating in the second end 56 of the housing 52. The second end 56 of the housing 52 may be tapered to form a conical surface 78 as shown in FIG. 5A.

An exterior seal or gasket 80 is mounted over and attached to the constant diameter end section 76 of the valve housing 52. By way of example only, the seal 80 is over molded on the end portion 76 of the valve housing 52. The over-molded seal 80, when formed, has a slightly tapered conical wall section 82 extending from a first end 84 engaged with the conical section 74 and the valve housing 52. The seal member 80 has an enlarged tip 86 which tapers inward to an end 88 spaced longitudinally outward from the second end 56 of the valve housing 52.

The over-molded seal 80 functions to seal the valve housing 52 to the internal surfaces of the shoulder 46 when the transmission sections 22 and 24 are joined together. Similarly, the O-ring 72 seals the valve housing 52 to the other transmission section 22.

A movable member in the form of a plunger 100 is part of the valve 50 and is responsive to engagement or disengagement the transmission section 24 as the sections 22 and 24 are urged together or separated. The movable plunger 100 is slidably disposed in the valve housing 52 for movement from a first extended position with respect to the second end 56 of the valve housing 52 to a second position corresponding an open fluid flow allowing position state of the valve 50 as shown in FIG. 5A.

The plunger 100, in one aspect, is formed as a two-part assembly including a stem 102 and a cap 104. The cap 104 in the form of a unitary one piece body formed of suitable plastic material and includes a semi-spherical shaped outer end 106 which has a flattened end surface 108, a first larger diameter flange 110, a radially inner cylindrical portion 112 which extends between the flange 110 and a second smaller diameter flange 114. A hollow interior bore 116 extends from the outer end of the second flange 114 into the interior of the cap 104, generally to an end co-planarly aligned with the first enlarged diameter flange 110.

The stem 102 is also formed, by example only, as a one piece unitary body of a suitable plastic material. The stem 102 includes a central spine 120 extending from a first end 124 to a second opposed end 126. A plurality of circumferentially angularly disposed ribs, with four ribs 128 as shown by example, extend radially outward from the spine 120. With four ribs 128, the ribs 128 are spaced 90° apart and define fluid flow paths, as described hereafter, between the first end 124 of the stem 102 around a disk shaped end 130 of the stem 102 defined by a circular shaped flange having a projection 132 extending outward therefrom co-axially with the spine 120.

As shown in FIGS. 1-6, the ends of the ribs 128 adjacent the second end 124 of the spine 120 are tapered radially outward to form an enlarged diameter angled end portion 129 relative to the linear portion 131 of the axial extent of each rib 128. This prevents the plunger 100 from being forced inward into the valve housing 42.

The cap 104 is press fit onto one end of the stem 102 by a friction fit between the inner bore 116 and the projection 132 on the cap 104. In this press fit state, the flange 130 at the second end of the stem 102 is spaced from the first diameter flange 110 on the cap 104. This provides a flow space for fluid between the exterior of the first flange 110 on the cap 104 and the flow paths between each pair of ribs 128.

The flange 110 also forms a seat for a biasing means 150 which can be in the form of a coil spring. The biasing means 150 has one end seated on the flange 110 of the cap 104, with the inner diameter of the biasing means 150 surrounding the semi-spherically shaped cap 106.

A retainer 160, generally in the form of a circular washer having a central aperture 162 is mounted through the first end 54 of the valve housing 52 and held against the shoulder 64 in the interior of the valve housing 52. The retainer 160 acts as a seat for the opposite end of the biasing means 150.

When the retainer 160 is firmly seated against the shoulder 64 in the interior of the valve housing 152, the thin wall end section 60 of the housing 52 is rolled-over or crimped on the circumferential periphery of the retainer 160 to fixedly hold the retainer 160 in position between the shoulder 64 in the valve housing 52.

In assembling the valve 50 to the transmission section 22, the first end 54 of the valve housing 52 is inserted into the enlarged bore portion 31 of the bore 26 in the transmission section 22. The outer diameter of the enlarged wall section 62 adjacent the first end 54 of the valve housing 52 has a diameter to interfere with the inner diameter of the bore portion 31 to form an interference or friction fit. The valve housing 52 is forced under pressure into the bore portion 31 until the collar 68 contacts and abuts the end 36 in the transmission section 22. At this time, the first seal 72 engages the inner surface at the end of the opening 34 to seal the housing 52 to the transmission section 22.

Continuing with the assembly of the valve 50, the cap 104 is initially inserted through the open first end 54 of the housing 52. With the cap 104 forcibly held against movement, the projection 132 on the end of the stem 102 is pressed fit into the bore 116 in the cap 104 to unitarily join the cap 104 to the stem 102.

It will be understood that the reversed sequence of operation where the stem 102 is held in a stationary position within the housing 52 and the cap 104 pressed fit over the projection 132 on the stem 102 can also be employed.

Alternately, a cap 104 can be initially inserted through the opened first end 54 of the valve housing 52. The biasing means 150 can then be inserted followed by the retainer 160. The outer edge of the endwall 60 of the housing can then be crimped over the periphery of the retainer 160. The stem 102 of the plunger 100 can then be inserted through the open second end 56 of the valve housing 52 until the projection 132 engages the opening of the bore 116 and the cap 104. Continued pressured insertion of the stem 102 into the valve housing 52 will force the projection 132 into the bore 116 in the cap 104 in a tight, substantially non-separable friction or interference fit.

When the cap 104 is unitarily joined to the stem 102, the entire plunger 100 and the cap 104 are prevented from sliding out of the second end 56 of the housing 52 by the engagement of the large diameter 110 on the cap 104 with inner surface 75 of the conical wall 74 in the intermediate portion of the housing 52.

The biasing means or spring 150 in then inserted through the opened first end 54 of the housing followed by the retainer 160. The edge of the thin wall section 60 of the housing 52 is then rolled over and crimped in position holding the retainer 160 in a fixed position seated on the shoulder 64 adjacent the first end 54 of the housing 52.

In a normal closed position of the valve 50 shown in FIG. 1, which occurs when the transmission sections 22 and 24 are separated and not joined together in close contact or proximity, the biasing means or spring 150 exerts a force against the flange 110 of the valve 50 moving the plunger 100 to the first position shown in FIG. 1 wherein the end 124 of the plunger 100 extends axially outward from the second end 56 of the valve housing 52 and the second end 88 of the over molded seal 80. In this position, a second seal member, such as O-ring 170, which is mounted in a recess formed between the cylindrical portion 112 of the cap 104 and the adjacent spaced first and second flanges 110 and 114, sealingly engages an inner surface 77 of the constant diameter wall 76 of the valve housing 52 to seal fluid within the bore 26 in the transmission section 22. This prevents fluid from escaping from the transmission section 24 through the opening 34 when the transmission sections 22 and 24 are separated. It also allows section 22 to be prefilled with fluid and pressurized prior to mating with section 22.

At the same time, the large diameter flange 110 on the cap 104 engages the inner surface 75 of the conical walls 74 of the valve housing 52 to limit extension of the second end 124 of the plunger 100 outward from the second end 56 of the housing 52.

An actuator is provided in the transmission sections 22 and 24 to actuate the movable member(s) of the valve 50 as the transmission sections 22 and 24 are urged together into the joined, fixed position and at the same time open the valve 50 to fluid flow through the first bore 26 to the second bore 42. In the example shown in FIGS. 1-7, the actuator is the inner shoulder 46 in the transmission section 24. Other examples of actuators will be described and illustrated in other aspects of the separable transmission 20.

Referring now to FIG. 6, when the transmission sections 22 and 24 are urged together in intimate contact for fixed joinder, the second end 124 of the valve plunger 100 will initially engage the shoulder 46 in the end portion of the bore 42 in the transmission section 24. As the transmission sections 22 and 24 are urged together, the transmission section 24 acting as an actuator through the shoulder 46 forces the plunger 100 of the valve 50 axially inward with the valve housing 52 to a second or open fluid flow position shown in FIG. 6. During this movement, the biasing means 150 compresses and the second seal member 170 disengages from contact with the inner surface 77 of the wall 75.

As shown in FIG. 6, when the valve plunger 100 reaches the second open position, fluid flow paths 129 are formed between the ribs 128 on the stem 102 between the end 124 of the stem 102 and an interior space surrounding the cap 104, the second seal 170 and the disc shaped end 130 of the stem 102. The flow paths allow fluid to flow through the bore 26 in the transmission section 22 to the bore 42 in the transmission section 24.

At any time the transmission sections 22 and 24 are separating, the relative movement between the facing ends 36 and 23 of transmission sections 24 and 22, respectively, will allow the biasing means 150 in the valve 50 to extend the plunger 100 back to the first position wherein the flange 110 engages the inner surface 75 and the second seal 170 engages the inner surface 77 of the wall 76 of the valve housing 52 closing off further fluid flow through the bore 26 in the transmission section 22.

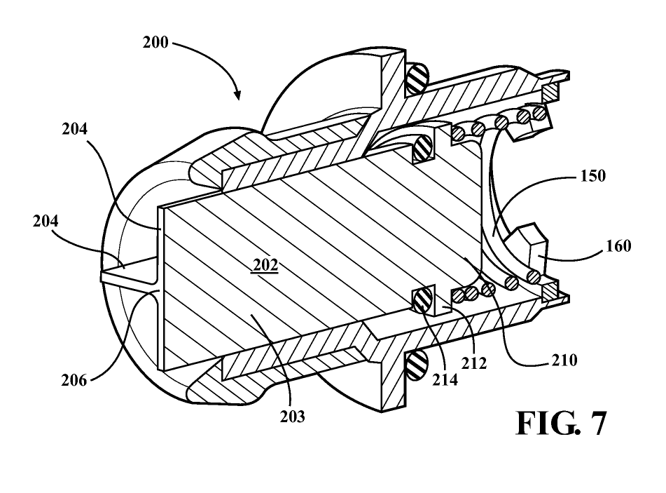

In FIG. 7, a valve 200 is similarly constructed to the valve 50 except for the shape of the plunger denoted by reference number 202. The plunger 202 is formed of a metallic material and has a stem 203 with a plurality of ribs, with four ribs 204 used by way of example only, extending radially outward from a central spine 206. The ends of the ribs 204 and one end of the spine 206 are co-planarly aligned as shown in FIG. 7.

The cap 104 of the valve 50 described above and shown in FIGS. 1-6 is replaced with a similarly shaped cap-like end portion 210 which is integrally formed as a single piece or unit with the stem 203 of the plunger 202. The plunger 202 is thus integrally formed as a one-piece body containing the stem 203 and the cap-like end portion 210 and a flange 212. With an O-ring 214. Otherwise, the function of the plunger 202 and the entire valve 200 is identical to that described above for the valve 50.

In this aspect of the valve 200, the plunger 202 is initially inserted through the open first end 54 of the valve housing 52 until the flange 212 engages the inner surface 75 of the conical wall 74. The biasing means 150 and the retainer 160 are then sequentially inserted through the open first end 54 of the valve housing 52 and the outer edge of the end 60 of the housing 52 rolled over or crimped in place about the periphery of the retainer 160.

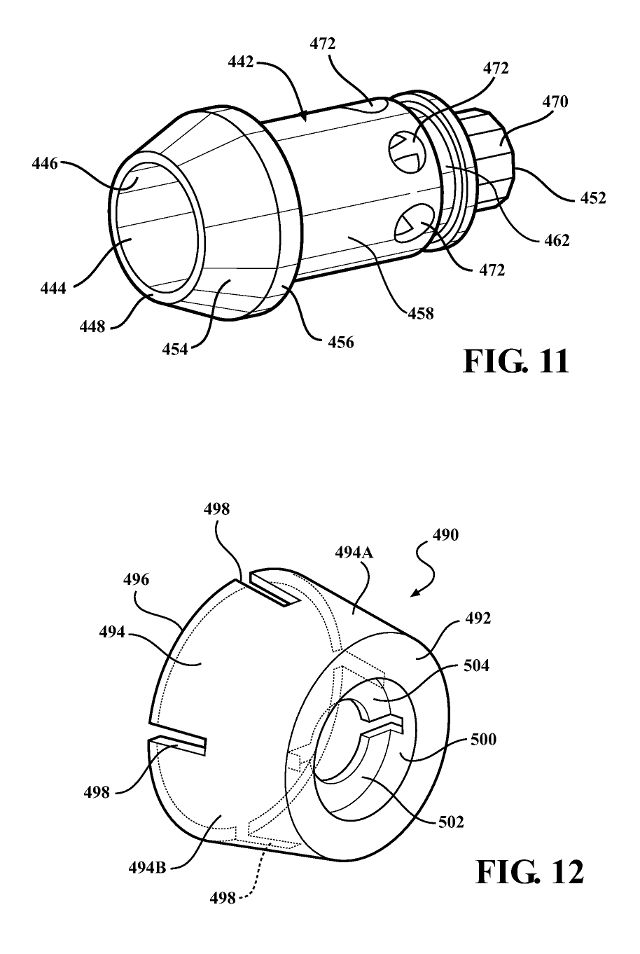

In another aspect shown in FIGS. 8-17, the no-leak feature of the transmission 20 is provided by a moveable valve 440, which is mounted in the bore portion 30 of bore 26 and moveable between a first, closed or fluid flow blocking position in which the valve 440 prevents fluid flow from the bore 26 through the open end 34 of the transmission section 22, when the transmission sections 22 and 24 are in a separated, spaced apart position, to a second, open, fluid flow allowing position which allows fluid flow from the bore 26 through the second bore 42 when the transmission sections 22 and 24 and are joined together.

In one aspect, the valve 440 includes a body 442. The body 442 may be a form of suitable high temperature resistant material, such as a metal, with aluminum being one example, or a plastic, such as nylon 12, for another example.

In the case of metal, the body 442 may be machined and/or cast to the illustrated shape. In the case of a plastic material, the body 442 may be molded and/or machined to the final shape shown in FIGS. 8-16.

By way of example, the body 442, in one aspect, includes a bore 444 extending from an opening 446 at a first end 448 of the body 442 to a closed second end 450 which terminates within the body 442 intermediate of the first end 448 and a closed second end 452 of the body 442.

The exterior surface of the body 442 includes a conical section 454 extending from the first end 448 for a predetermined distance. The conical outer end section 454 transitions into a constant diameter portion 456, for example, before transitioning to a small diameter cylindrical surface 458 which extends at a constant diameter along an intermediate portion of the body 442. A shoulder 460 is formed between the end of the constant diameter portion and the reduced diameter surface 458 of the body 442. The shoulder 460 acts as a seat for one end of a biasing means 480, such as a spring, described in detail hereafter.

The cylindrical surface 458 extends along the intermediate portion of the body toward the second end 452 on the body 442. A recess 462 is formed in the constant diameter surface 458 for receiving a seal 464, which may be an O-ring. After transiting outward at the end of the recess 462 back to the outer diameter of the cylindrical surface 458, the exterior surface of the body 442 transitions inward to a reduced diameter section 466. An inward projecting recess 468 extends radially inward from the section 466 to form a radially extending recess. The exterior surface then extends outward to form a cylindrical portion 470 extending to the second end 452 of the body 442.

A plurality of fluid flow apertures or outlets 472 are formed in a circumferentially spaced arrangement in the body 442. The apertures 472 extend through the wall of the cylindrical surface 458 and are located at the second internal end 450 of the bore 444 within the body 442. The apertures 472 allow fluid flow entering the bore 444 through the opening 446 in the first end 448 of the body 442 to be discharged from the body 442 into the surrounding area which, in the present case, is the bore 26 shown in FIG. 8.

As shown in FIG. 10, a biasing means 480, such as a spring, is mounted about the constant diameter surface 458 and seats at one end against the shoulder 460 on the valve body 442. The biasing means or spring 480 functions to bias the valve 440 to the normal closed position within the bore 26 when the actuator describe hereafter, disengages from the valve body 442.

Although a coil spring could be used for the biasing means 480, in one example, a Smalley Stainless Wave Spring is employed. This spring has an advantage of space savings, as compared to coil springs, while still providing the required amount of spring force.

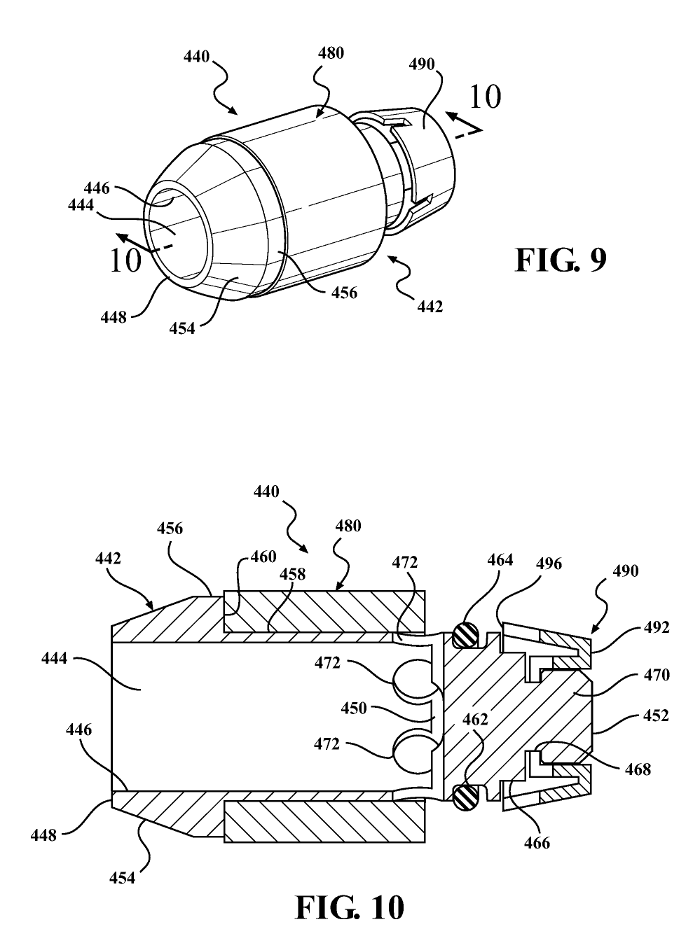

As shown in FIGS. 9 and 10, and in greater detail in FIG. 12, a cap 490 is fixedly mounted on the valve body 442 and functions to prevent removal of the valve 442 from the bore 26 in the transmission 20 when the valve 440 is moved to the first fluid flow blocking position. The cap 490 thereby serves as a stop limiter to define the first closed position of the valve 440 in the bore 26.

The cap 490 may be made of a suitable plastic such as an acetal, for example. The cap 490 has the first angular ring-like end 492. A conical or outward tapered surface 494 extends from the annular end 492 to an opposed second end 496. The conical surface 494 includes a plurality of cutouts or notches 498, preferably formed in diametrically opposed pairs, which divide the entire conical surface 494 into a series of bendable wings, with diametrically opposed wings 494A and 494B shown by example only in FIG. 12. In the normally relaxed radially outer disposed position shown in FIGS. 10 and 12, the ends 496 of the wings 494A and 494B are disposed at an inner spacing or diameter which is greater than the inner diameter of the inner diameter portion 30 of the bore 26. This enables the ends 496 of the wings 494A and 494B to engage the shoulder 32 in the bore 26 to firmly seat the valve 440 in the first, fluid flow blocking position. The wings 494A and 494B also prevent separation of the valve 440 from the bore 26 though the open end 34 in the transmission section 22.

An inner surface 500 projects downward from the annular end 492 of the cap 490. The inner surface 500 is divided into at least two separate sections 502 and 504 which respectively terminate in radially inward extending ribs or ledges 506 and 508. The ledges 506 and 508 are positioned to engage the recess 468 in the valve body 442 to fixedly lock the cap 490 on the valve body 442.

The wings 494A and 494B uniquely enable the entire valve 440 to be inserted from one side and in one direction of the transmission section 24. To install the valve 440 in the transmission section 24, the cap 490 is installed on the valve body 442 by forcibly urging the cap 490 over the cylindrical end 470 of the valve body 442. This initial forced engagement causes the ledges 502 and 504 to bend outward a slight amount until the outer edges pass the outer diameter of the cylindrical end 470 of the valve body 442. At a suitable insertion distance, the ledges 502 and 504 snap into the recess 468 in the valve body 442 to lock the cap 490 on the valve body 442.

In order to install the entire valve 440 in the bore 26, the valve 440 is inserted into the bore 26 through the opening 34 in the exterior surface 36 of the transmission section 22 cap 490 end first. The peripheral tip portion of the wings 494A and 494B of the cap 490 will engage in the inner diameter surface of the bore 26 and be forced radially inward into close proximity with the inner surface 500 of the cap 490 until the wings 494A and 494B reach a diameter allowing further insertion of the cap 490 past the shoulder 32. At this point, the wings 494A and 494B snap radially outward to a normal, relaxed position. The biasing means 480 will bias the valve to the first, closed position shown FIG. 13 in which position the ends of wings 494A and 494B of the cap 490 firmly seat against the shoulder 32 in the bore 26.

The valve 440 is movable between the first and second positions through interaction with the first and second transmission sections 22 and 24 as the first and second transmission sections 22 and 24 are separated apart or moved toward each other into joined engagement. In one aspect, the valve 440 is moved between the first and second positions by an actuator carried by or formed on a portion of the second transmission section 24 as the second transmission section 24 is moved away from or toward the first transmission section 22.

An actuator 320 seen in FIG. 13 is carried on and moves with the transmission section 22. The actuator 420, in one aspect, is a tubular sleeve 422 having a first end 426 firmly seated within at least a partial bore in the transmission section 22 and an opposed second end 424 which projects from the exterior surface 23 of the transmission section 24 into an end portion of the bore 26 in the opposite transmission section 22 to engage and move the valve 440 to the second, open position when the transmission sections 22 and 24 are joined together. The tubular sleeve 422 may be formed of any transmission suitable material. Further, the tubular sleeve 422 may be hollow or solid or have any other internal design. By way of example only, the second end portion 424 of the tubular sleeve 422 has a conical inner surface 428 complimentary to the shape of the conical surface 454 on the first end of the valve body 442 of the valve 440 to firmly engage and seat against the valve body 442.

When the transmission sections 22 and 24 are separated, the actuator 420 disengages from the valve 440. This disengagement allows the biasing means 480 to move the valve body 442 back to the normal closed position preventing fluid from discharging from the bore 26 while the transmission sections 22 and 24 are separated. When the transmission sections 22 and 24 are subsequently rejoined, the end 428 of actuator 420 will engage the conical end 454 of the valve body 442 during an initial stage of reengagement of the transmission sections 22 and 24 and move the valve body 442 to second open position again allowing fluid flow from the bore 26 through the remaining flow passages in the transmission sections 22 and 24.

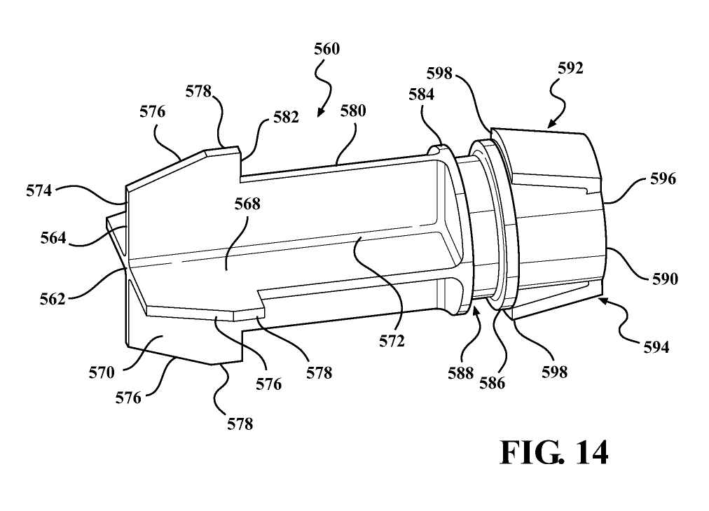

Another aspect of a valve or valve body 560 is shown in FIGS. 14, 15 and 16. In this aspect, the cap is integrated as a unitary part of the valve body 560.

The valve body 560 has a first end 562 from which a plurality of ribs, with four ribs 564, 566, 568 and 570, shown by way of example only, extend in a radially outward direction from a center axis or spine 572. Each rib 564, 566, 568 and 570 has an identical shape which includes a flat end wall 574 co-linear with the first end 562, and a conical or angled edge 576 which transitions into a constant diameter edge 578. Each rib 564, 566, 568 and 570 also has a linear reduced diameter portion 580 which extends from a shoulder 582 positioned between an end of the linear portion 580 and the constant diameter portions 578 of each rib. The linear portions 580 of each of the ribs 564, 566, 568 and 570 terminate in an annular, solid disc 584. A second substantially constant diameter disc 586 is also formed on the valve body 560 and spaced from the disc 584 to form a recess 588 for a seal member, such as an O-ring 599. A constant diameter cylindrical end portion 590 extends from the second disc 586. A plurality of wings, with two wings 592 and 594 shown by way of example only, are integrally formed with the cylindrical end portion 590 and are connected to the cylindrical end portion 590 adjacent a second end 596 of the valve body 560. Each of the wings 592 and 594 tapers slightly angularly outward from the exterior surface of the cylindrical end portion 596 from the connection to the cylindrical end portion 596 to a free, movable end 598. The moveable ends 598 of the wings 592 and 594 are normally spaced apart in a relaxed position at a diameter greater than the inner diameter of the bore 26. This allows the ends 598 of the wings 592 and 594 to forcibly engage the shoulder 32 formed between the different diameter portions 30 and 28 of the bore 26 to seat the valve 440 in the bore 26 when the valve body 560 in the first, closed, fluid blocking position.

A biasing means 581, such as a biasing similar to the biasing means or spring 480 shown in FIG. 10, is mounted about the exterior surface of the linear portion 580 of each rib 564, 566, 568 and 570 and seats at one end against the shoulder 582 and an inner wall of the transmission section 22. The biasing means 581 serves the same function as the biasing means or spring 480 in the prior aspect of the valve body 442.

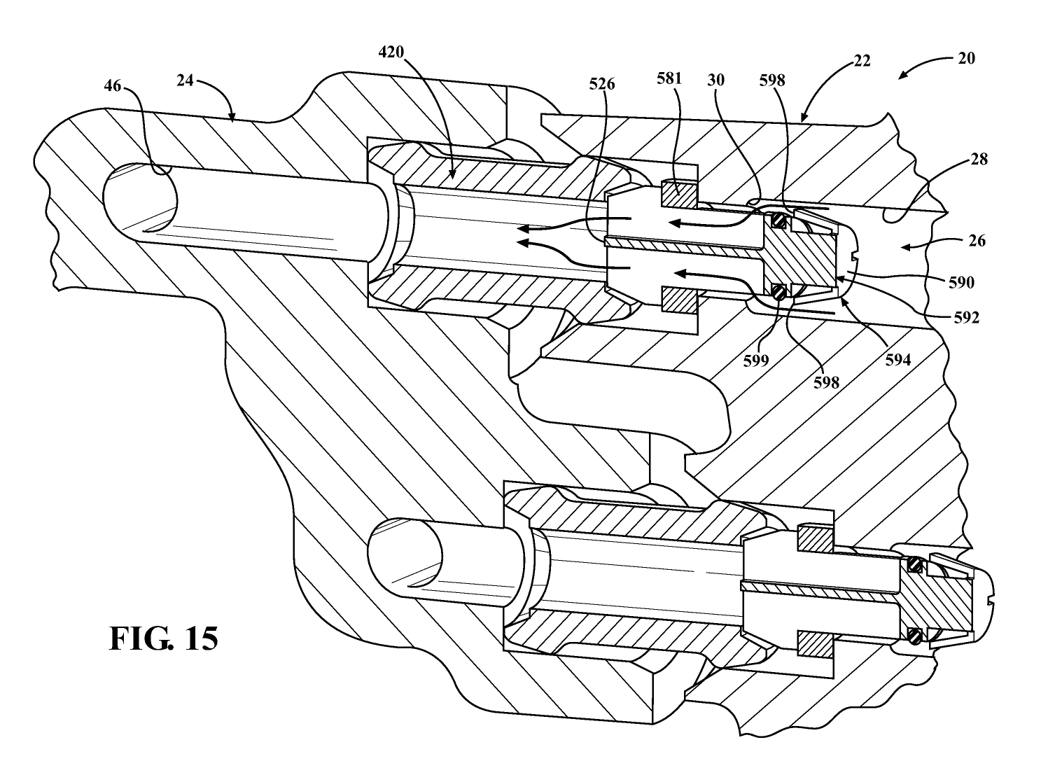

In use, the actuator 420, shown in FIG. 15, engages and moves the valve body 560 to the second, open, fluid flow allowing position as the first and second transmission sections 22 and 24 are moved toward each other into joined engagement. The actuator 420 will initially engage either or both of the linear end portions 574 or the conical edges 576 of each of the ribs 564, 566, 568 and 570 to firmly engage the valve body 560 for movement to the second valve position. When in the second position shown in FIG. 15, annular passageways, denoted by the arrows in FIG. 15, are formed between adjacent pairs of ribs 564, 566, 568 and 570 and the surrounding portion of the bore 26 in the transmission section 22 to allow fluid flow from the first end 34 at the bore 26 in either direction, such as from the first end 562 of the valve body 560 through the annular passageways and out of the ends of the annular passageways adjacent the annular disc 584 and into the main portion of the bore 26. An opposite fluid flow direction through the bore 26 and the valve 560 toward the open end 34 of the transmission section 22 is also possible.

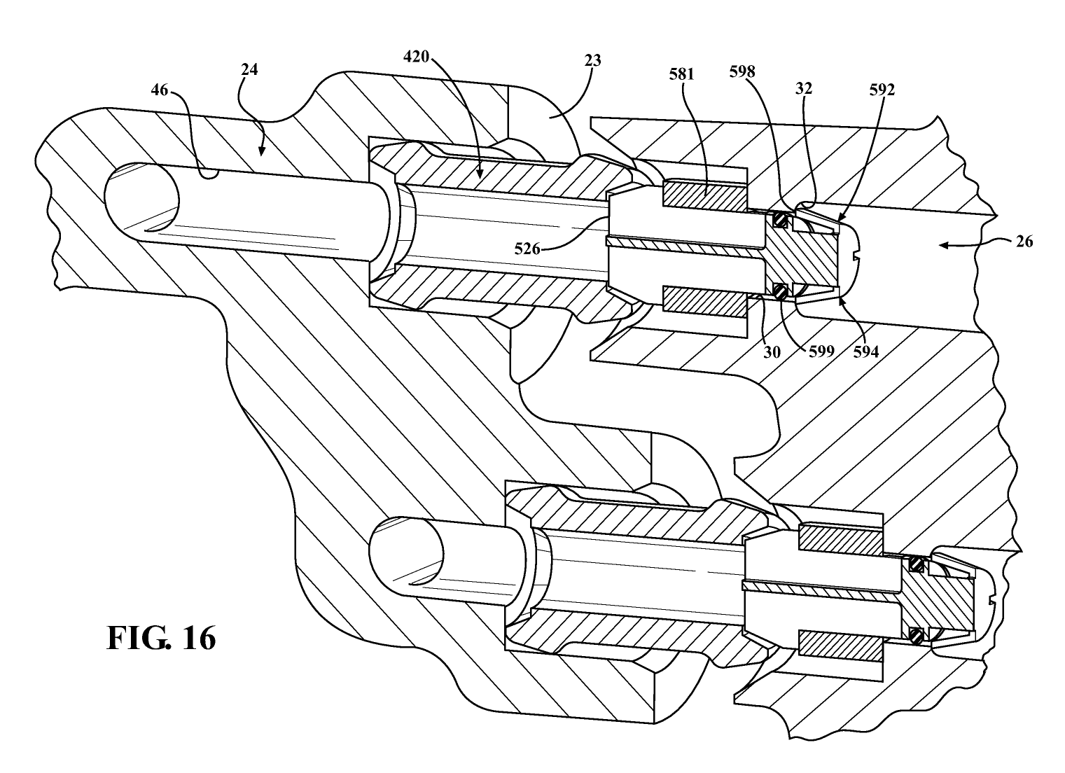

When the transmission sections 22 and 24 are separated, as seen in FIG. 16, the relative movement of the transmission section 24 away from the end of the transmission section 22, or vice versa, disengages the actuator 420 from the end of the valve body 560. This allows the biasing spring 581 to move the valve body 560 to the first closed position in which the end of the body 560 projects exteriorly of the end of the transmission section 22. The seal member or O ring 599 engages an inner surface of the bore portion 30 of the bore 26. At the same time, the ends 598 of the wings 592 and 594 engage the shoulder 32 in the bore 26 stopping further movement of the valve body 560 and in conjunction with the seal member 599 defines the first closed, fluid flow blocking position of the valve 560. In this position, the valve 560 automatically closes off fluid flow which might occur through the open end of the bore 26 when the transmission sections 22 and 24 are separated.

What is claim is:

1. A transmission comprising:
at least first and second separable transmission sections;
a first fluid flow passageway extending through the first and second transmission sections, the first fluid flow passageway including a first bore in the first separable transmission section disposed in the fluid flow in communication with a second bore in the second separable transmission section; and
a valve mounted in the first bore in the first transmission section blocking fluid flow from the first bore when the first and second transmission sections are separated.

2. The transmission of claim 1 further comprising:
the valve including a movable portion, the movable portion movable between a first position closing the valve to fluid flow from the first bore in the first transmission section and a second position allowing fluid flow from the first bore in the first transmission section to the second bore in the second transmission section.

3. The transmission of claim 2 further comprising:
an actuator moving the movable portion of the valve between the first and second positions as the first and second transmission sections are respectively separated and moved together.

4. The transmission of claim 1 wherein the valve comprises:
a housing fixedly mountable in the first bore in the first transmission section.

5. The transmission of claim 3 wherein the movable portion of the valve comprises:
a plunger movably mounted within the valve housing and having first and second opposed ends;
the first end of the plunger disposed exteriorly of the valve housing and disposed for moveable contact with the actuator as the first and second transmission sections are joined or separated.

6. The transmission of claim 4 further comprising:
a first seal member carried on the valve housing for sealing the valve housing in the first bore to the first transmission section.

7. The transmission of claim 5 further comprising:
a second seal member, carried on the plunger, for sealing the plunger to an interior surface of the valve housing when the plunger is in the first fluid flow blocking position.

8. The transmission of claim 4 further comprising:
biasing means, carried in the valve housing, for normally biasing the plunger to the first position.

9. The transmission of claim 5 wherein the plunger comprises:
a stem carrying a plurality of radially outwardly extending ribs, the ribs defining axial flow paths along the stem; and
a cap fixedly engageable with the stem, the cap including an exterior surface engageable with an inner surface of the valve housing when the plunger is in the second position defining the first fluid flow blocking position of the valve.

10. The transmission of claim 9 wherein:
the stem and the cap are integrally formed as a unitary one-piece member mountable as a unit within the valve housing.

11. The transmission of claim 4 further comprising:
an exterior seal member, mountable over an end portion of the valve housing extending exteriorly of the bore in the first transmission section, the exterior seal member engageable with an inner surface of the second bore in the second transmission section when the first and second transmission sections are joined together in affixed relationship.

12. The transmission of claim 2 further comprising:
biasing means, carried on the valve and engageable with a portion of the first separable section, for normally biasing the valve to the first position.

13. The transmission of claim 1 further comprising:
means, responsive to separation and engagement of the first and second separate sections of the transmission, for moving the valve between the first and second positions.

14. The transmission of claim 13 wherein the moving means comprises:
an actuator extending from the second separable section through the opening in the bore in the first section when the first and second sections are joined together to engage and move the valve from the first position to the second position.

15. The transmission of claim 14 wherein:
the actuator is a member mounted in a bore in the second section.

16. The transmission of claim 2 further comprising:
biasing means, carried on the valve, and engageable with a portion of the one of the first and second separable sections, for normally biasing the movable position of the valve to the first closed position.

17. The transmission of claim 1 wherein the valve further comprises:
a body having opposed first and second ends;
an internal bore formed in the body extending from the first end to a closed second end intermediate the first and second ends of the body; and
at least one aperture in the body disposed in fluid flow of communication with the internal bore in the body to allow fluid flow through the internal bore in the body and the first bore in the first transmission section when the valve is in the second position.

18. The transmission of claim 17 wherein the at least one aperture comprises:
a plurality of radially extending, circumferentially spaced apertures.

19. The transmission of claim 1 wherein the valve further comprises:
a body having first and second opposed ends; and
an angularly movable leg carried adjacent the second end of the body for engaging a portion of the first transmission section in the first bore in the first transmission section to position the valve in the first position when the first and second transmission sections are separated.

20. The transmission of claim 19 wherein:
the angularly movable leg is carried on a cap separably joinable to the body.

21. The transmission of claim 1 wherein the valve comprises:
a body having opposed first and second ends;
a plurality of radially extending, circumferentially spaced legs carried on the body and extending from the first end of the body to an opposed second end intermediate the first and second ends of the body, the legs defining axial fluid flow passages extending from the first end of the body to the second end of the plurality of legs; and
the axial passages between the plurality of legs terminating in a wall at the second end of the legs.

22. The transmission of claim 21 further comprises:
an angularly movable leg carried on the second end of the valve body for engaging a portion of the first transmission section in the first bore to position the valve in the normal first position.

23. The transmission of claim 22 wherein:
the angularly movable leg is integrally formed as a unitary part of the valve body.

24. The transmission of claim 21 wherein:
means, responsive to separation and engagement of the first and second separate sections of the transmission, for moving the valve between the first and second positions.

25. The transmission of claim 24 wherein the moving means comprises:
an actuator extending from the second separable section through the opening in the bore in the first section when the first and second sections are joined together to engage and move the valve from the first position to the second position.

26. The transmission claim 25 wherein:
the actuator is a member mounted in a bore in the second section.

27. The transmission of claim 4 further comprising:
an inner diameter of the bore in the first transmission section and an outer diameter of one end portion of the valve housing configured for an interference fixed mounting of the one end of the valve housing in the first bore in the first transmission section.

28. The transmission of claim 8 further comprising:
a retainer carried in the valve housing and defining a seat for the biasing means.

29. The transmission of claim 28 further comprising:
an aperture formed in the retainer to define a portion of a fluid flow path through the one end portion of the valve housing.

30. The transmission of claim 28 further comprising:
a crimp on an end portion of the one end portion of the housing fixing the retainer in the one end of the housing.

31. The transmission of claim 1 further comprising:
an interface spanning and coupling the first bore in the first transmission section in fluid flow communication with the second bore in the second transmission section when the first and second transmission sections are joined together.

32. The transmission of claim 31 wherein the interface comprises:
the valve sealingly coupled to the first bore in the first transmission section and the second bore in the second transmission section when the first and second transmission sections are joined together.

33. The transmission of claim 31 wherein the interface comprises:
a tubular member sealingly coupled in the second bore of the second transmission section and having an opened end; and
the valve in the first bore in the first transmission section sealingly coupled in the opened end of the tubular member when the first and second transmission sections are joined together.

34. The transmission of claim 1 wherein:
the valve defines a fluid flow path between the first bore in the first transmission section and the second bore in the second transmission section when the first and second transmission sections are joined together.
